(19) United States
(12) Patent Application Publication
(10) Pub. No.: US 2009/0111022 A1
(43) Pub. Date: Apr. 30, 2009

(54) ELECTRODE COMPOSITIONS AND METHODS

(75) Inventors: Jeffrey R. DAHN, Upper Tantallon (CA); Dinh Ba LE, St. Paul, MN (US); Pierre P. FERGUSON, Halifax (CA); Mark N. OBROVAC, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/237,781

(22) Filed: Sep. 25, 2008

Related U.S. Application Data
(60) Provisional application No. 60/982,295, filed on Oct. 24, 2007.

(51) Int. Cl. H01M 4/62; H01M 4/38; H01M 4/04

(52) U.S. Cl. 429/217; 429/218.1

(57) ABSTRACT

Provided is an electrode composition comprising an active material that includes cobalt, tin, and carbon along with methods of making and using the same. Also provided are electrodes that include the provided electrode compositions, electrochemical cells that include the provided electrodes, and battery packs that include at least one of the provided electrochemical cells. In some embodiments, the composition also includes iron.

### RELATED APPLICATIONS

This application claims priority to U.S. Provisional Patent Application Nos. 60/982,295, filed Oct. 24, 2007 and 61/074,190, filed Jun. 20, 2008.

### FIELD

This invention relates to anode compositions for electrochemical cells and to electrodes containing binders, and methods of making electrodes and cells.

### BACKGROUND

Powdered alloys and conductive powders such as carbon black have been used to make electrodes for lithium-ion cells in a process that involves mixing the powdered active ingredients with a polymeric binder. The mixed ingredients are prepared as a dispersion in a solvent for the polymeric binder, and coated onto a metal foil substrate, or current collector. The resulting composite electrode contains the powdered active ingredient in the binder adhered to the metal substrate.

Many polymers have been used as binders for metal and graphite based lithium-ion cell electrodes. However, the first cycle irreversible capacity loss in the resulting cells can be unacceptably large, e.g., as large as 300 mAh/g or more for an electrode based on a powdered metal material.

Alloy anode materials that contain tin, cobalt, and carbon have been used to make negative electrodes for use in lithium-ion cells. These materials can use high amounts of carbon (greater than 10 wt %, for example) in the alloys in order to retain capacity after repeated cycling.

### SUMMARY

In view of the foregoing, we recognize that there is a need for electrodes that undergo reduced first cycle capacity loss (irreversible capacity loss), reduced capacity fade during repeated cycling, and large volumetric capacities.

In one aspect, provided is an electrode composition that includes an active material comprising an alloy of tin, cobalt, and carbon, wherein the amount of carbon is less than 9.9 weight percent (wt %) and greater than 1 wt % of the total active material.

In another aspect, provided is an electrode composition that includes and active material comprising an alloy of tin, cobalt and carbon, and a non-fluorine-containing binder or an aromatic binder or a combination thereof, wherein the amount of active material includes from about 10 wt % to about 30 wt % carbon and the weight ratio of cobalt to the total weight of tin and carbon is from about 0.3 to about 0.7.

In yet another aspect, provided is an electrode composition that includes an active material comprising an alloy of tin, cobalt, iron, and carbon, wherein the amount of iron is greater than 5.9 wt % of the total amount of active material.

In yet another aspect, provided is a method of making an alloy that includes milling a plurality of powdered ingredients comprising powdered carbon, powdered cobalt, and a powdered alloy that includes cobalt and tin. The powdered alloy can include CoSn₂. The cobalt can be present in a molar amount that is substantially equal to the molar amount of cobalt in the alloy.

Also provided are electrodes made from these active materials, electrochemical cells made from provided electrodes, and a battery pack that includes at least one of the electrochemical cells provided herein.

The provided electrodes can improve cycle life in rechargeable lithium-ion cells employing electrodes based on small particle alloy powders—especially alloys that include tin, cobalt, and carbon. The disclosed binders can also allow fabrication of rechargeable lithium-ion cells having improved capacities and decreased irreversible capacities even when the amount of carbon in the alloy is below 10 weight percent (wt %).

The disclosed method of making electrode compositions can provide compositions useful in the formation of negative electrodes. Of particular interest are negative electrode materials that include cobalt, tin, carbon, and optionally iron that are made by the method herein described.

In this document:

“a”, “an”, and “the” are used interchangeably with “at least one” to mean one or more of the elements being described;

“active” refers to a material that can undergo lithiation and delithiation;

“alloy” refers to a hybrid of two or more elements, at least one of which is a metal, and where the resulting material has metallic properties;

“charge” and “charging” refer to a process for providing electrochemical energy to a cell;

“delithiate” and “delithiation” refer to a process for removing lithium from an electrode material;

“discharge” and “discharging” refer to a process for removing electrochemical energy from a cell, e.g., when using the cell to perform desired work;

“lithiate” and “lithiation” refer to a process for adding lithium to an electrode material;

“metal” refers to both metals and to metalloids such as silicon, and carbon, whether in an elemental or ionic state;

“positive electrode” refers to an electrode (often called a cathode) where electrochemical reduction and lithiation occurs during a discharging process;

“nanocrystalline phase” refers to a phase having crystallites no greater than about 50 nanometers (nm); and

“negative electrode” refers to an electrode (often called an anode) where electrochemical oxidation and delithiation occurs during a discharging process.

### BRIEF DESCRIPTION OF THE DRAWINGS

FIG. 1a displays the X-ray diffraction (XRD) pattern of a Sn₃₆Co₄₁C₂₃ alloy prepared by sputtering.

FIG. 1b displays the XRD pattern of a Sn₃₀Co₃₀C₄₀ sample prepared from carbon powder, cobalt powder and CoSn₂ alloy powder as starting materials.

FIG. 1c displays the diffraction pattern of a Sn₃₀Co₃₀C₄₀ sample prepared from carbon powder, and CoSn alloy powder.

FIGS. 2a-c display differential capacity (dQ/dV) vs. potential (V) for the samples of FIGS. 1a-c.

FIG. 3 displays specific capacity (mAh/g) vs. cycle number for the materials described in FIGS. 1a-c and FIGS. 2a-c.

FIG. 4 illustrates X-ray diffraction patterns of embodiments of provided electrode compositions.

FIG. 5 illustrates cycle characteristics of two embodiments and one comparative example.

### DETAILED DESCRIPTION

In the following description, reference is made to the accompanying set of drawings that form a part of the description hereof. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Provided electrode compositions include an active material that contains an alloy of tin, cobalt, and carbon. The amounts of tin, cobalt, and carbon in these compositions can vary significantly. In some embodiments the amount of carbon is less than 9.9 wt % of the total weight of the active material. In other embodiments, the active material includes from about 10 wt % to about 30 wt % carbon and the weight ratio of cobalt to the total of tin and cobalt is within the range of about 0.3 to about 0.7. The cobalt, tin, and carbon can be added separately when making the compositions of this disclosure or an alloy of tin and cobalt such as, for example, CoSn₂, can be mixed with carbon and additional cobalt, if the amount of cobalt in the desired electrode composition exceeds 0.5 the amount of tin. Carbon, for example, such as graphitic carbon powder can be used to make the disclosed electrode compositions. It is preferred that the active material is in the form of a powder. After charging in a lithium-ion cell, the active materials of the electrode compositions can include lithium.

Provided electrode compositions can also include active materials that include tin, cobalt, carbon, and iron. The iron can be in the composition in an amount of greater than 5.9 wt % based upon the total amount of active material in the composition.

The active materials of the provided composition can include powders. Exemplary powders can have a maximum length in one dimension that is no greater than 60 μm, no greater than 40 μm, or no greater than 20 μm, or even smaller. The powders can, for example, have a maximum particle diameter that is submicron, at least 1 μm, at least 2 μm, at least 5 μm, or at least 10 μm or even larger. For example, suitable powders often have a maximum dimension of about 1 μm to about 60 μm, from about 10 μm to about 60 μm, from about 20 μm to about 60 μm, from about 40 μm to about 60 μm, from about 1 μm to about 40 μm, from about 2 μm to about 40 μm, from about 10 μm to about 40 μm, from about 5 μm to about 20 μm, or from about 10 μm to about 20 μm.

Exemplary powdered alloy materials can be prepared by any known means, for example, by physically mixing and then milling the. various precursor components to form the materials. Provided alloy materials can also be prepared by means of sputter deposition of an alloy film. The sputter deposited alloy films can subsequently be ground into a powder. When conductive coatings are employed, they can be formed using techniques such as electroplating, chemical vapor deposition, vacuum evaporation or sputtering.

Suitable milling can be done by using various techniques such as vertical ball milling, horizontal ball milling or other milling techniques known to those skilled in the art. An attritor mill can also be used to make the herein described materials. This milling process is called attritor milling. Of particular significance is a method of making electrode compositions comprising cobalt, tin, and carbon that is presented later in this disclosure.

Provided electrode compositions can include nanocrystalline materials. Nanocrystalline materials typically have a maximum crystallite dimension of from about 5 nm to about 50 nm. The crystalline size can be determined from the width of an x-ray diffraction peak using the Scherrer equation. Narrower x-ray diffraction peaks correspond to larger crystal sizes. The x-ray diffraction peaks for nanocrystalline materials typically can have a peak width at half the maximum peak height corresponding to greater than 0.5 degrees 2θ, greater than 1 degree 2θ, greater than 2 degrees 2θ, greater than 3 degrees 2θ, or greater than 4 degrees 2θ using a copper target (i.e., copper Kα1 line, copper Kα2 line, or a combination thereof), where 2θ is in a range from 10° to 80°. The provided electrode compositions can also be amorphous.

The electrode compositions can include a binder. When the electrode composition includes an active material that can be an alloy of tin, cobalt, and carbon where the amount of carbon is less than 9.9 wt % and greater than 1 wt % based upon the total weight of active material, the binder can be any known binder. Binders that can be used for the provided electrodes include, for example, polyvinylidene fluorides, polyimides, polystyrenes, carboxymethyl celluloses, lithium polysalts, or others known to those of skill in the art. Particularly useful binders include polymers that include one or more organic acids groups. Exemplary polymers can include poly(meth)acrylates, polysulfonates, polystyrenesulfonates, polyphosphonates, polysulfonate fluoropolymers, and the like. The acidic polymers can be useful as binders as well as the neutralized lithium salts thereof.

Provided binders can include lithium polysalts. Lithium polysalts include lithium poly(meth)acrylates, lithium polystyrenesulfonates, and lithium polysulfonate fluoropolymers. The lithium polysalts are available from the corresponding acrylic or sulfonic acids by neutralization of the acidic groups with basic lithium. Commonly lithium hydroxide is used to neutralize acid groups. It is also within the scope of this application to replace other cations, such as sodium, with lithium by ion exchange. For example, an ion exchange resin such as DIANION (available from Mitsubishi Chemical), can be used to exchange sodium ion for lithium ion.

While not being bound by theory, it is believed that lithium polysalts can coat powdered active materials and form a layer which is ionically conductive. Since lithium-ion electrochemical cells depend upon lithium ion conductivity this enhances the ability of electrodes made with these binders to have extended life and reduced fade. Additionally, it is believed that the provided lithium polysalts coat the powdered active materials thinly enough that some electrical conductivity is maintained. Finally, it is believed that the lithium polysalts can suppress the formation of insulating SEI (solvent electrolyte interface) layers that are known by those skilled in the art to lead to premature lithium-ion electrode failure on repeated cycling. Exemlary lithium polysalts are disclosed in PCT App. No. PCT/US2008/051,388, filed Jan. 24, 2008.

In some embodiments, the provided binders include at least about 50 mole %, at least about 60 mole %, at least about 70 mole %, at least about 80 mole %, at least about 90 mole %, or even more, of lithium based upon the molar equivalents of acidic groups (on the ends or on pendant groups) of the acid from which the polysalt is derived. Acidic groups that can be neutralized include carboxylic acid, sulfonic acid, phosphonic acid, and any other acidic group that has one proton to exchange that are commonly found on polymers. Examples of commercial materials that are useful in this invention include perfluorosulfonic acid polymers such as NAPHION (available from DuPont, Wilmington, Del.), and thermoplastic ionomeric polymers such as SURLYN (also from Dupont). Other materials of interest include lithium polyimides such as those described in U.S. Pat. No. 6,287,722 (Barton et al.)

Lithium polyacrylate can be made from poly(acrylic acid) that is neutralized with lithium hydroxide. In this application, poly(acrylic acid) includes any polymer or copolymer of acrylic acid or methacrylic acid or their derivatives where at least about 50 mole %, at least about 60 mole %, at least about 70 mole %, at least about 80 mole %, or at least about 90 mole % of the copolymer is made using acrylic acid or methacrylic acid. Useful monomers that can be used to form these copolymers include, for example, alkyl esters of acrylic or methacrylic acid that have alkyl groups with 1-12 carbon atoms (branched or unbranched), acrylonitriles, acrylamides, N-alkyl acrylamides, N,N-dialkylacrylamides, hydroxyalkylacrylates, maleic acid, propanesulfonates, and the like. Of particular interest are polymers or copolymers of acrylic acid or methacrylic acid that are water soluble—especially after neutralization or partial neutralization. Water solubility is typically a function of the molecular weight of the polymer or copolymer and/or the composition. Poly(acrylic acid) is very water soluble and is preferred along with copolymers that contain significant mole fractions of acrylic acid. Poly(methacrylic) acid is less water soluble—particularly at larger molecular weights.

Homopolymers and copolymers of acrylic and methacrylic acid that are useful in this invention can have a molecular weight (M_{w}) of greater than about 10,000 grams/mole, greater than about 75,000 grams/mole, or even greater than about 450,000 grams/mole, or even higher. The homopolymers and copolymer that are useful in this invention have a molecular weight (M_{w}) of less than about 3,000,000 grams/mole, less than about 500,000 grams/mole, less than about 450,000 grams/mole, or even lower. Carboxylic acidic groups on the polymers or copolymers can be neutralized by dissolving the polymers or copolymers in water or another suitable solvent such as tetrahydrofuran, dimethylsulfoxide, N,N-dimethylformamide, or one or more other dipolar aprotic solvents that are miscible with water. The carboxylic acid groups (acrylic acid or methacrylic acid) on the polymers or copolymers can be titrated with an aqueous solution of lithium hydroxide. For example, a solution of 34 wt % poly(acrylic acid) in water can be neutralized by titration with a 20 wt % solution of aqueous lithium hydroxide. Typically, 50% or more, 60% or more, 70% or more, 80% or more, 90% or more, 100% or more, 107% or more of the carboxylic acid groups are lithiated (neutralized with lithium hydroxide) on a molar basis. When more than 100% of the carboxylic acid groups have been neutralized this means that enough lithium hydroxide has been added to the polymer or copolymer to neutralize all of the groups with an excess of lithium hydroxide present. Lithium polyacrylate binders have been disclosed, for example, in U.S. Ser. No. 11/671,601 (Le), filed Feb. 6, 2007.

Lithium polysulfonate fluoropolymers can be made from the corresponding polysulfonic acid fluoropolymers by neutralizing the polysulfonic acid fluoropolymers with a base such as lithium hydroxide. The sulfonic acid groups on the polymers can be titrated with an aqueous solution of lithium hydroxide. For example, a solution of 8.8% polysulfonic acid fluoropolymer in water can be neutralized by titration with a 20 wt % of aqueous lithium hydroxide. Typically, 50% or more, 60% or more, 70% or more, 80% or more, 90% or more, or all of the sulfonic acid groups are lithiated (neutralized with lithium hydroxide) on a molar basis.

In this application, polysulfonate fluoropolymers include fluoropolymers having pendant groups terminating in sulfonic acid groups. The polysulfonate fluoropolymers can be derived from polysulfonic acid fluoropolymers that comprise a highly fluorinated backbone and pendant groups, wherein the pendent groups comprise:

HO₃S—(CFR_{f})ₐ(CFR_{f})_{b}-Z₁-(CFR_{f})_{c}(CFR_{f})_{d}-Z₂-

wherein each of a, b, c, and d independently ranges from 0-3, c+d is at least one, Z₁ and Z₂ are an oxygen atom or a single bond, and each R_{f} is independently either F or a substantially fluorinated, branched or unbranched fluoroalkyl, fluoroalkoxyl, or fluoroether group that contains 1 to 15 carbon atoms and 0 to 4 oxygen atoms in the fluoroalkyl, fluoroalkoxyl, or fluoroether chain. Examples of suitable pendant groups include —OCF₂CF(CF₃)OCF₂CF₂SO₃ H; —O(CF₂)₄SO₃H, and combinations thereof.

The backbone or pendant chains of the fluoropolymer or both can be substantially or fully fluorinated (perfluorinated). Substantially fluorinated backbone or pendant chains include about 40% or more by weight fluorine, based upon the entire weight of the chain. The fluoropolymer can also include one or more acidic endgroups, such as sulfonyl endgroups having the formula —SO₃H. In one embodiment, the backbone chain of the fluoropolymer is perfluorinated. Other suitable polysulfonate fluoropolymers that can be useful in some embodiments of the provided compositions can be found in U.S. Pat. No. 6,287,722 (Burton et al.); U.S. Pat. No. 6,624,328 (Guerra) and U. S. Pat. Publ. No. 2004/0116742 (Guerra); and Applicants' copending application, U.S. Ser. No. 10/530,090 (Hamrock et al.). Other materials useful in some embodiments of the provided compositions include lithium polysulfonate fluoropolymers derived from copolymers of tetrafluoroethylene (TFE) and a co-monomer according to the formula: FSO₂—CF₂—CF₂—O—CF(CF₃)—CF₂—O—CF═CF₂. These are known and are sold in sulfonic acid form, i.e., with the FSO₂— end group hydrolyzed to HSO₃—. One such exemplary material is NAPHION available from DuPont Chemical Company, Wilmington, Del.

U.S. Pat. Nos. 4,358,545 and 4,417,969 (both to Ezell et al.) disclose polymers and ion exchange membranes thereof having a hydration product of less than about 22,000 and equivalent weights of 800-1500, which have a substantially fluorinated backbone and pendant groups according to the formula: YSO₃—(CFR¹_{f})_{c}(CFR²_{f})_{d}—O-backbone, where Y is hydrogen or an alkali metal, R¹_{f} and R²_{f} are substantially fluorinated alkyl groups, c is 0-3, d is 0-3,and c+d is at least 1. These materials can be used to derive (by neutralization) lithium polysulfonate fluoropolymers that are useful in some embodiments of the provided compositions and methods.

Lithium polystyrenesulfonates can be made from the corresponding polystyrenesulfonic acids by neutralizing the polystyrenesulfonic acids with a base such as lithium hydroxide. The sulfonic acid groups on the polymers can be titrated with an aqueous solution of lithium hydroxide. For example, a solution of 5% polystyrenesulfonic acid in water can be neutralized by titration with a 20% by weight solution of aqueous lithium hydroxide. Typically, 50% or more, 60% or more, 70% or more, 80% or more, 90% or more, or all of the sulfonic acid groups are neutralized with lithium hydroxide on a molar basis. Alternatively, sodium polystyrenesulfonate is available as a solution in 70,000 and 500,000 molecular weight from Polysciences, Inc., Warrington, Pa. and the sodium can be exchanged for lithium by passage through a lithium loaded cation exchange resin. Polystyrenesulfonates with molecular weights of from about 10,000 to about 2,000,000 can be useful in the provided bonders. Provided polystyrenesulfonates include polymers or copolymers of styrenesulfonic acid. In most instances there can be one sulfonic acid group on the benzene ring of the styrene moiety. It can usually be in the para or 3-position on the ring. The benzene ring of the styrene can be further substituted with other groups including, but not limited to, branched or unbranched alkyl or alkoxy groups containing from about 1 to about 6 carbon atoms. In addition other substitution can be possible as long as the substituent does not materially interfere with the acidity of the sulfonic acid group.

Sulfonated polymers that can be useful as binders include poly(aryl sulfonates) such as polystyrenesulfonate, copolymers of styrene sulfonate, such as the copolymer of styrene sulfonate and maleic anhydride; copolymers of acrylamide and 2-methyl-1-propanesulfonate; homopolymers and copolymers of vinylsulfonates, homopolymers and copolymers of allyl sulfonates and homopolymers and copolymers of alkyl vinyl benzene sulfonates. Other potentially useful polymers for the provided binders can be found in U.S. Pat. No. 5,508,135 (Lelental et al.).

In another embodiment provided are polyacrylonitrile-based binders for alloy negative electrode compositions. Polyacrylonitrile (PAN) is known to react in air at temperatures from 200° C. to 300° C. to form ribbon-like polymeric carbon known as “black orion”. Scheme (I) shows the thermal chemistry of polyacrylonitrile (PAN).

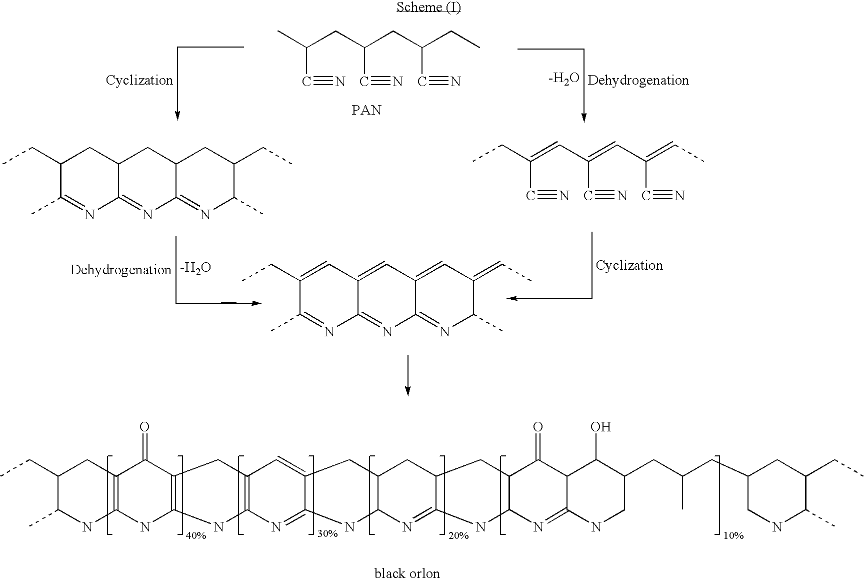

Black orion is a ladder polymer that has very good thermal and mechanical stability. Electrodes that were constructed using black orion as a binder had similar electrochemical performance to those made with polyimide (PI).

In another embodiment, provided are binders that comprise organic polymers and simple organic substances that are cured in an inert atmosphere at a temperature greater than 200° C. Included are phenolic resins such as those discussed in U.S. Pat. Nos. 7,150,770 and 7,150,771 (both to Keipert et al.) and molecules such as glucose.

When the electrode composition includes an active material that comprises an alloy of tin, cobalt, and carbon, the binder can be a non-fluorine-containing binder. A non-fluorine-containing binder is any material that is used as a binder that has no fluorine as a backbone component or as a substitutent. Exemplary non-fluorine-containing binders include polyimides, carboxymethyl cellulose, lithium polysulfonates, phenolic resins, polyacrylonitriles, polyacrylates, lithium polyacrylates, and the like. Alternatively, the electrode composition can include an aromatic binder. By aromatic binder it is meant that the binder includes an aromatic moiety. Aromatic binders may or may not include fluorine. Exemplary aromatic binders include polyfluorosulfonates and their lithium salts, polyimides, phenolic resins, and the like.

The provided binders can be mixed with other polymeric materials to make a blend of materials. This may be done, for example, to increase the adhesion, to provide enhanced conductivity, to change the thermal properties, or to affect other physical properties of the binder.

To make an electrode, the active composition, additives such as binders, conductive diluents, fillers, adhesion promoters, thickening agents for coating viscosity modification such as carboxymethylcellulose and other additives known by those skilled in the art are mixed in a suitable coating solvent such as water or N-methylpyrrolidinone (NMP) to form a coating dispersion or coating mixture. The dispersion is mixed thoroughly and then applied to a foil current collector by any appropriate coating technique such as knife coating, notched bar coating, dip coating, spray coating, electrospray coating, or gravure coating. The current collectors are typically thin foils of conductive metals such as, for example, copper, aluminum, stainless steel, or nickel foil. The slurry is coated onto the current collector foil and then allowed to dry in air followed usually by drying in a heated oven, typically at about 80° C. to about 300° C. for about an hour to remove the solvent.

Provided electrochemical cells require an electrolyte. A variety of electrolytes can be employed. Representative electrolytes can contain one or more lithium salts and a charge-carrying medium in the form of a solid, liquid or gel. Exemplary lithium salts are stable in the electrochemical window and temperature range (e.g. from about −30° C. to about 70° C.) within which the cell electrodes can operate, are soluble in the chosen charge-carrying media, and perform well in the chosen lithium-ion cell. Exemplary lithium salts include LiPF₆, LiBF₄, LiClO₄, lithium bis(oxalato)borate, LiN(CF₃SO₂)₂, LiN(C₂F₅SO₂)₂, LiAsF₆, LiC(CF₃SO₂)₃, and combinations thereof. Exemplary electrolytes are stable without freezing or boiling in the electrochemical window and temperature range within which the cell electrodes can operate, are capable of solubilizing sufficient quantities of the lithium salt so that a suitable quantity of charge can be transported from the positive electrode to the negative electrode, and perform well in the chosen lithium-ion cell. Exemplary solid electrolytes include polymeric media such as polyethylene oxide, fluorine-containing copolymers, polyacrylonitrile, combinations thereof and other solid media that will be familiar to those skilled in the art. Exemplary liquid electrolytes include ethylene carbonate, propylene carbonate, dimethyl carbonate, diethyl carbonate, ethyl-methyl carbonate, butylene carbonate, vinylene carbonate, fluoroethylene carbonate, fluoropropylene carbonate, γ-butylrolactone, methyl difluoroacetate, ethyl difluoroacetate, dimethoxyethane, diglyme (bis(2-methoxyethyl) ether), tetrahydrofuran, dioxolane, combinations thereof and other media that will be familiar to those skilled in the art. Exemplary electrolyte gels include those described in U.S. Pat. No. 6,387,570 (Nakamura et al.) and U.S. Pat. No. 6,780,544 (Noh). The solubilizing power of the electrolyte can be improved through addition of a suitable cosolvent. Exemplary cosolvents include aromatic materials compatible with Li-ion cells containing the chosen electrolyte. Representative cosolvents include sulfolane, dimethoxyethane, combinations thereof and other cosolvents that will be familiar to those skilled in the art. The electrolyte can include other additives that will familiar to those skilled in the art. For example, the electrolyte can contain a redox chemical shuttle such as those described in U.S. Pat. No. 5,709,968 (Shimizu), U.S. Pat. No. 5,763,119 (Adachi), U.S. Pat. No. 5,536,599 (Alamgir et al.), U.S. Pat. No. 5,858,573 (Abraham et al.), U.S. Pat. No. 5,882,812 (Visco et al.), U.S. Pat. No. 6,004,698 (Richardson et al.), U.S. Pat. No. 6,045,952 (Kerr et al.), and U.S. Pat. No. 6,387,571 B1 (Lain et al.); and in U.S. Pat. Appl. Publ. Nos. 2005/0221168 A1, 2005/0221196 A1, 2006/0263696 A1, and 2006/0263697 A1 (all to Dahn et al.).

The electrode composition can contain additives such as will be familiar to those skilled in the art. The electrode composition can include an electrically conductive diluent to facilitate electron transfer from the composition to a current collector. The conductive diluent can be added to the electrode composition that comprises tin, cobalt, and carbon in order to increase the contact of the composition with the current collector. Electrically conductive diluents include, but are not limited to, carbon (e.g., carbon black for negative electrodes and carbon black, flake graphite and the like for positive electrodes), metal, metal nitrides, metal carbides, metal silicides, and metal borides. Representative electrically conductive carbon diluents include carbon blacks such as SUPER P and SUPER S carbon blacks (both from MMM Carbon, Belgium), SHAWANIGAN BLACK (Chevron Chemical Co., Houston, Tex.), acetylene black, furnace black, lamp black, graphite, carbon fibers and combinations thereof.

The electrode composition can include an adhesion promoter that promotes adhesion of the composition and/or electrically conductive diluent to the binder. The combination of an adhesion promoter and binder can help the electrode composition better accommodate volume changes that can occur in the composition during repeated lithiation/delithiation cycles. The binders can offer sufficiently good adhesion to metals and alloys so that addition of an adhesion promoter may not be needed. If used, an adhesion promoter can be made a part of the binder (e.g., in the form of an added functional group), can be a coating on the composition, can be added to the electrically conductive diluent, or can be a combination of such measures. Examples of adhesion promoters include silanes, titanates, and phosphonates as described in U.S. Pat. Appl. Publ. No. 2004/0058240 (Christensen).

The provided electrochemical cells are made by taking at least one each of a positive electrode and a negative electrode as described above and placing them in an electrolyte. Typically, a microporous separator, such as CELGARD 2400 microporous material, available from Celgard Corp., Charlotte, N.C., can be used to prevent the contact of the negative electrode directly with the positive electrode.

Positive electrodes useful in the provided electrochemical cells can include, for example, lithium transition metal oxides such as, LiV₃O₈, LiV₂O₅, LiCo_{0.2}Ni_{0.8}O₂, LiNiO₂, LiFePO₄, LiMnPO₄, LiCoPO₄, LiMn₂O₄, and LiCoO₂; the cathode compositions that include mixed metal oxides of cobalt, manganese, and nickel such as those described in U.S. Pat. Nos. 6,964,828 and 7,078,128 (Lu et al.); and nanocomposite cathode compositions such as those described in U.S. Pat. No. 6,680,145 (Obrovac et al.).

The electrochemical cells made with negative electrodes comprising compositions provided herein can have specific capacities of greater than 250 mAh/g, greater than 350 mAh/g, or even greater than 450 mAh/g after 100 charge/discharge cycles. The provided cells also can have reduced irreversible capacity loss and less fade than known cells. Electrochemical cells made with negative electrodes provided herein can be used in a variety of devices, including portable computers, tablet displays, personal digital assistants, mobile telephones, motorized devices (e.g., personal or household appliances and vehicles), instruments, illumination devices (e.g., flashlights) and heating devices. One or more electrochemical cells made with the negative electrodes comprising provided compositions can be combined to provide battery pack. Further details regarding the construction and use of rechargeable lithium-ion cells and battery packs will be familiar to those skilled in the art.

In another aspect, provided is a method of making an alloy comprising tin, cobalt and carbon that includes milling a plurality of powdered ingredients comprising carbon powder, cobalt powder, and a powdered alloy that includes cobalt and tin. Alloys comprising cobalt and tin can be made, for example, by arc melting elemental tin and elemental cobalt. The alloy comprising cobalt and tin may furthermore be subjected to annealing. For instance annealing may be accomplished by heating the alloy comprising cobalt and tin at 500° C. for 24 hours under flowing argon gas, followed by 900° C. for 12 hours under flowing argon gas. The alloy comprising cobalt and tin can furthermore be ground into a powder by milling. Alloys comprising cobalt and tin that can be important include, for example, CoSn and CoSn₂.

It has been found that when cobalt and graphitic carbon are added to an alloy of cobalt and tin and then milled with a high energy ball mill or preferably with an attritor mill, that electrode materials can be made with properties such as low irreversible capacity and stable cycling characteristics that are superior to materials that result from just mixing cobalt, tin, and carbon and milling.

In one embodiment, a material of the formula, Sn₃₀Co₃₀C₄₀ was made using two different starting materials, CoSn and CoSn₂ as described in detail in the Example section. In addition a sputtered sample of an alloy of cobalt, tin, and carbon having the formula, Sn₃₆Co₄₁C₂₃ was made. In other embodiments formulations the include iron, cobalt, tin, and carbon were made as shown in Table 1.

Objects and advantages of this invention are further illustrated by the following examples, but the particular materials and amounts thereof recited in these examples, as well as other conditions and details, should not be construed to unduly limit this invention.

### EXAMPLES

Preparation of Poly(acrylic acid) (PAA, neutralized with LiOH) Solution

Starting material A: 15.258 g LiOH.H₂O (Sigma-Aldrich) was mixed with 137.610 g distilled water using a magnetic stirrer. The formed LiOH.H₂O solution was 9.98 wt % LiOH.

Starting material B: 25 wt % PAA solution (Alfa Aesar, Mn 240,000). 128.457 g of material A was added into 88.045 g material B. The mixture was stirred overnight. The formed solution was 11 wt % PAA (100% Li salt-all acid neutralized without excess) binder solution. This solution was diluted to 8 wt % PAA by addition of water.

### Preparation of Co—Sn—C Samples

Sn₃₀Co₃₀C₄₀ samples were alloyed mechanically by vertical-axis attritor milling (using a 01-HD attritor, available from Union Process, Akron, Ohio). Exemplary samples were prepared from CoSn₂, Co (Sigma-Aldrich, <150 μm, 99.9+%), CoSn₂ alloy and graphite (graphite purum powder available from Fluka) starting materials, but one comparative example was prepared from CoSn and graphite in the vertical-axis attritor mill. Both the CoSn₂ and CoSn were arc melted from elemental Sn (Sigma-Aldrich, <150 μm, 99.5%) and Co followed by annealing, respectively, at 500° C. for 24 hours under flowing argon and 900° C. for 12 hours under flowing argon. The annealed material was then ground into powder by hand using a mortal and pestle.

An 8.0 gram reactant charge was used in the vertical-axis attritor mill. About 1,400 0.67 cm diameter stainless steels balls along with the reactants were loaded into the 700 mL stainless steel attritor mill can. The attritor mill can was mounted within a water cooling jacket and maintained at about 20° C. during milling. The can was equipped with a sealed cover through which the rotating shaft projects. The shaft seal and bearings were modified in-house to provide an air-tight long-term seal. The rotating shaft had eight mixing arms that violently stirred the balls and reactant charge. The angular velocity of the shaft was set at 700 revolutions per minute (RPM) for these examples. Milling times of 4, 8, 12 and 16 h were used for attritor milling. Powder handling and loading of the attritor mill can were performed inside an argon-filled glove box.

Sputtered Sn₃₆Co₄₁C₂₃ (composition determined by electron microprobe analysis) was produced using a V3-T sputter deposition system (available from Corona Vacuum Systems, Vancouver, B.C., Canada). The base pressure reached by the system before sputtering was about 1×10⁻⁷ Torr (1.33×10⁻⁵ Pa). Deposition took place under Ar gas at a pressure of about 2.0 mTorr (0.266 Pa) using graphite and CoSn (50:50 molar ratio) targets. The graphite target (˜50 mm diameter by ˜6 mm thickness, 99.999% pure) was obtained from Kurt J. Lesker, Pittsburgh, Pa.). The Co₅₀Sn₅₀ target was prepared by arc melting a stoichiometric mixture of cobalt and tin powders followed by pouring under argon into a target mold. The resulting target disc was then machined to be 50 mm diameter by 6 mm thickness.

Substrates for sputtering were mounted on a 40 cm diameter rotating table. The table rotated past the graphite and CoSn targets continuously at about 15 rpm, ensuring that submonolayer coatings of carbon and CoSn were sequentially applied to the substrates. This was done to ensure as intimate mixing of the elements as possible with the aim of preparing nanostructured or amorphous materials. The procedure used was the same as used in A. D. W. Todd, et al., J. Electrochem. Soc., 154, A597 (2007), to produce Sn—Co—C sputtered samples, except here a constant composition over the entire sputtering table was produced, instead of combinatorial libraries. This was accomplished by using constant masks as described in J. R. Dahn, et al., Chemistry of Materials, 14, 3519 (2002), over the sputtering targets. Sputtering continued for 7 hours and a total film thickness of about 1.5 μm was obtained. Materials were sputtered on: 1) pre-weighed Cu discs for coin cell electrodes and mass per unit area data; 2) Si (100) wafer pieces for electron microprobe analysis and X-ray diffraction measurements and 3) a large area of 25 μm thick polystyrene film. The sputtered material on polystyrene was converted to powder by dissolving the polystyrene in toluene and rinsing the obtained powder in toluene six times. The recovered sputtered powder was used, just like powder from mechanical milling or from attritor milling, to make electrodes for coin cells.

### Preparation of Co—Sn—Fe—C Samples

A sample of FeSn₂ was prepared by melting iron powder and tin powder in an arc oven at a molar ratio of 1:2 (Fe:Sn). The FeSn₂ sample was heated in a tube furnace at 490° C. for 70 hours under a flowing Ar atmosphere. The annealed FeSn₂ sample was ground into a powder. The ground FeSn₂ sample was passed through a 300 μm sieve to remove the larger particles. Co—Sn—Fe—C alloys were prepared by milling various amounts of CoSn₂, FeSn₂, Fe, Co, and graphite powders. These alloys samples were prepared using a Union Process 01-HD attritor processing system (Union Process Inc., Akron, Ohio) For each example, a total of 25 g of powders of the appropriate ratios were placed in a stainless steel attritor vessel along with approximately 1400 stainless steel balls (6.35 mm diameter). This operation was carried out under an argon atmosphere. Mill was carried out at a setting of 700 RPM for 16 hours. Table 1 lists the molar ratios for Examples 3-11 and Comparative Example A.

TABLE 1
Molar Ratios of Examples 1-12 (mole percent (mol %))

| Sample | Mol % Co | Mol % Sn | Mol % Fe | Mol % C |
|---|---|---|---|---|
| Example 1 | 41 | 36 | 0 | 23 |
| Example 2 | 30 | 30 | 0 | 40 |
| Example 3 | 27 | 30 | 3 | 40 |
| Example 4 | 24 | 30 | 6 | 40 |
| Example 5 | 21 | 30 | 9 | 40 |
| Example 6 | 18 | 30 | 12 | 40 |
| Example 7 | 15 | 30 | 15 | 40 |
| Example 8 | 12 | 30 | 18 | 40 |
| Example 9 | 9 | 30 | 21 | 40 |
| Example 10 | 6 | 30 | 24 | 40 |
| Example 11 | 3 | 30 | 27 | 40 |
| Comparative | 0 | 30 | 30 | 40 |
| Example A | | | | |

### Preparation of Electrodes

The electrodes were coated on Cu foils with a weight to weight ratio of 80% of milled or the sputtered powder, 12% SUPER-S carbon black (MMM Carbon, Belgium) and 8% Li-PAA binder. The electrodes were dried at 90° C. overnight before use. The sputtered film left directly on Cu foil obviously did not require these steps and was used directly. 100 μL of electrolyte solution (1M LiPF₆ in 90 wt % ethylene carbonate (EC)): diethylene carbonate (DEC) (1:2 v/v) (available from Ferro Chemicals (Zachary, La.)); 10 wt % fluoroethylene carbonate (FEC) (available from Fujian Chuangxin Science and Technology Development, Ltd., Fujian, China)) were mixed and used as the electrolyte. Disks (16-mm diameter) were cut from the electrode coatings for use in 2325-coin cells. Each 2325 cell contained a 18 mm diameter disk of Cu as a spacer (36-mil (900 μm) thick), an 18 mm diameter disk of the alloy electrode, one 20 mm diameter microporous separator (CELGARD 2400; Separation Products, Hoechst Celanese Corp., Charlotte, N.C.), 18 mm diameter lithium (0.38 mm thick lithium ribbon; Aldrich Chemicals, Milwaukee, Wis.) and an 18 mm diameter copper spacer (600 μm thick). Coin cells were assembled in an argon-filled glove box.

Coin cells with Example 1-11 and Comparative Example A materials were made as described above except that the anode and the lithium foil discs were 12.7 mm in diameter.

### Electrochemical Testing Protocol

For all cells, the same electrochemical testing protocol was used. The theoretical capacities of the milled materials (707 mAh/g) or the sputtered materials (661 mAh/g) were calculated assuming that only Sn and C are active with 4.4 Li for every atom of Sn and 0.5 Li for every C atom. After the assembly, the coin cells were discharged from open circuit (near 2.7 V) to 0.005 V. The potential was then increased to 2.5 V to be decreased again to 0.005 V. This was done for a total of two cycles at a C/10 rate, as calculated prior from the expected theoretical capacity. After the first two cycles, the cells were discharged-charged from 0.005 V to 1.2 V at a C/5 rate for many cycles.

The powders from the three synthesis methods described above were studied by X-ray diffraction using a Siemens D-5000 diffractometer equipped with a Cu-target X-ray tube and a diffracted-beam monochromator. Each X-ray scan was collected from 10 to 90 degrees in 0.05° increments at 5 sec/point.

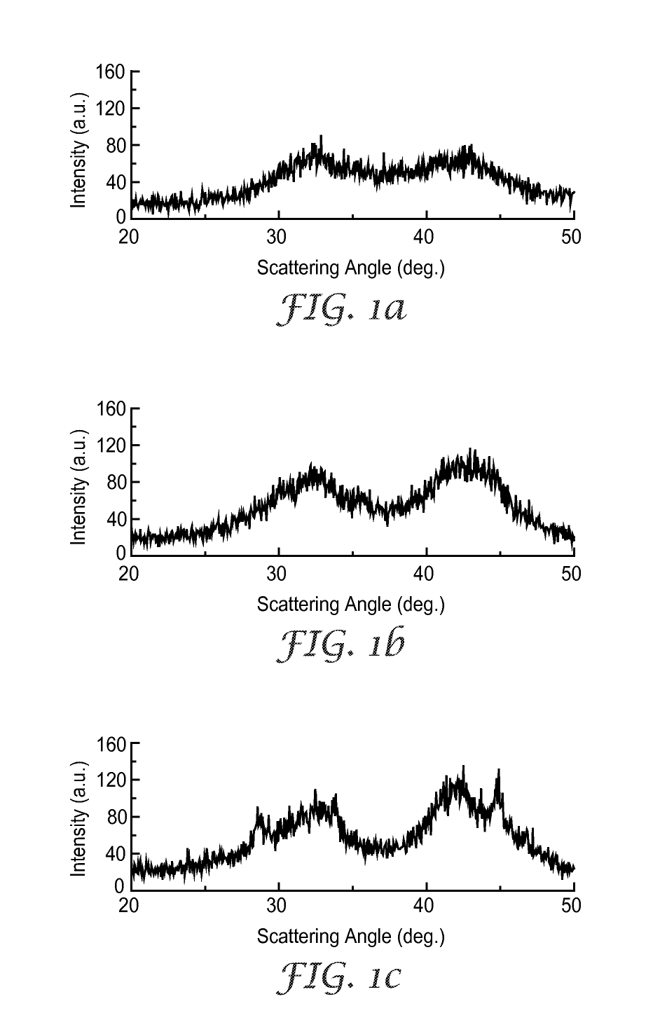

FIGS. 1a-c shows a comparison of the most nanostructured material (attritor—16 hours), from an X-ray point of view, with the sputtered powder. FIG. 1a shows the diffraction pattern of the sputtered Sn₃₆Co₄₁C₂₃ sample (Example 1) and FIG. 1b shows the pattern of the Sn₃₀Co₃₀C₄₀ (Example 2) sample prepared in the attritor mill. It is clear that even though the stoichiometries of the samples are slightly different, the diffraction patterns in FIGS. 1a and 1b are very similar, both two broad humps at about 32° and 43°. FIG. 1c shows the diffraction pattern of a sample prepared in the attritor mill under the same conditions as the sample shown in FIG. 1b, except that the crystalline phase CoSn was used as a starting material instead of CoSn₂. When CoSn and graphite were used as starting materials, Bragg peaks from CoSn can still be seen after 16 hours of milling. However, the two broad humps at 32° and 43° can still be observed in FIG. 1c. These results show that the choice of starting material plays a role in the time needed to reach a highly nanostructured product by vertical-axis attritor milling.

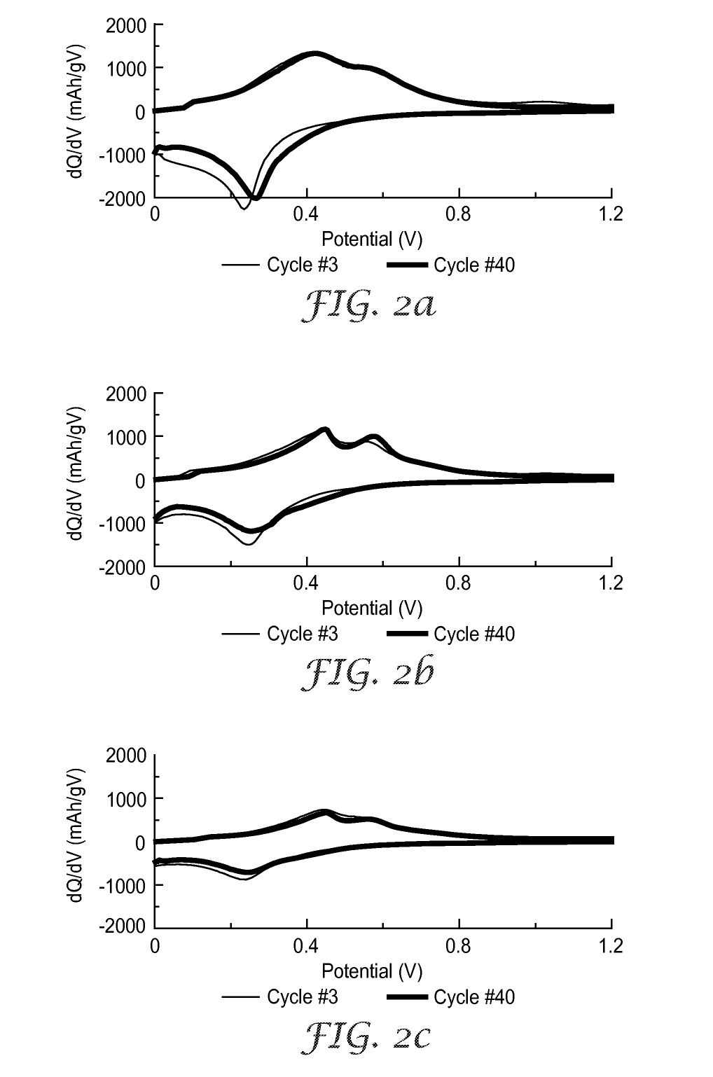

FIGS. 2a-c show the differential capacity (dQ/dV) vs. potential (V) for the three samples described by FIGS. 1a-c measured at both cycle 3 and cycle 40. The data were collected between 0.005 and 1.2 V at a C/5 rate. The sputtered powder described by FIG. 2a shows a smooth, featureless dQ/dV pattern which agrees well with the data in J. R. Dahn, et al., J. Electrochem. Soc., 153, A361 (2006). The samples produced in the attritor mill show more structure in dQ/dV versus V, suggesting larger regions of tin are formed from larger regions of nanostructured CoSn (separated by disordered carbon). The differential capacity versus potential is basically unchanged for all three samples over the course of 40 cycles, suggesting capacity retention should be excellent.

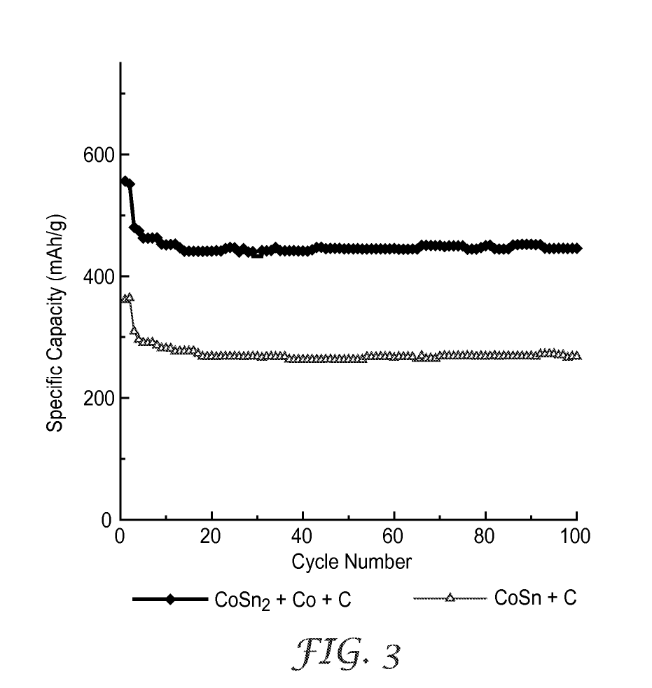

FIG. 3 shows the specific capacity (mAh/g) retention vs. cycle number for coin cells made from the Sn₃₀Co₃₀C₄₀ samples (Example 2). One sample was made by milling CoSn₂, Co, and C. The other sample was made by milling CoSn with C. Although the method used to make the samples produced materials with different specific capacities both samples have excellent capacity retention through 100 cycles as shown in FIG. 3.

FIG. 3 also shows that the Sn₃₀Co₃₀C₄₀ sample (Example 2) prepared by attritor milling CoSn₂, Co and graphite for 16 hours had a specific capacity near 470 mAh/g (0.005 V to 1.2 V, C/5) in the early cycles, which dropped slightly to 450 mAh/g by cycle 100. The theoretical capacity of this material is 707 mAh/g. By contrast, the Sn₃₀Co₃₀C₄₀ sample prepared from CoSn and graphite under the same milling conditions had an initial specific capacity near 300 mAh/g which dropped to about 270 mAh/g after 100 cycles.

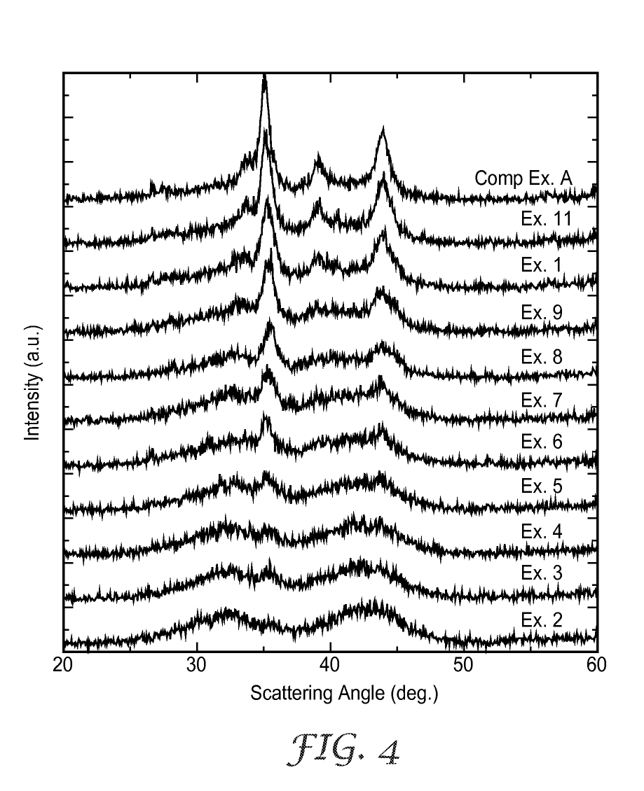

FIG. 4 illustrates the room temperature X-ray diffraction patterns of Example 2 (Sn—Co—C), Examples 3 to 11 (Sn—Co—Fe—C) and Comparative Example 12 (Sn—Fe—C). The two broad humps in Example 2 diffraction pattern are observed throughout all the diffraction patterns of Examples 3 to 11 and Comparative Example A along with an increasing feature related to Bragg peaks of FeSn₂ and/or CoSn₂. The diffraction pattern of Example Comparative Example A shows Bragg peaks of FeSn₂. Fe-carbide, crystalline iron and other Fe—Sn Bragg peaks were not observed in any of the Examples 2 to 11 and Comparative Example A diffraction patterns.

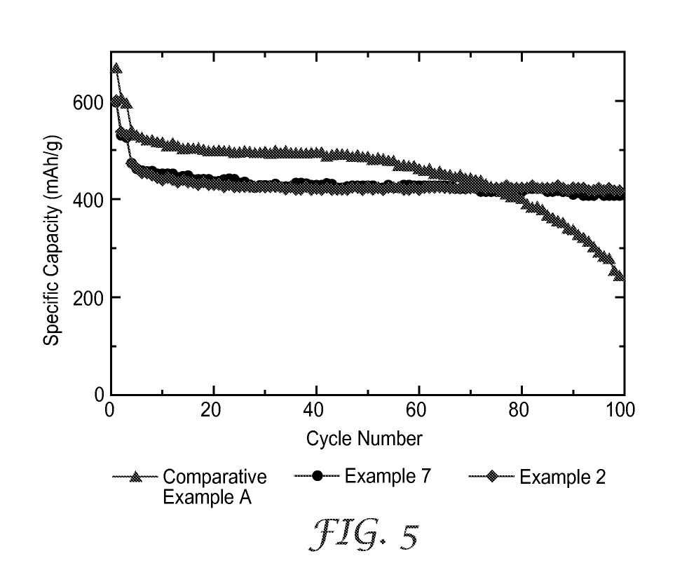

Cycle characteristics were measured for the obtained coin cell batteries. FIG. 5 shows the specific capacity versus cycle number for coin cells made from three prepared samples, Examples 2, 7, and Comparative Example A. The coin cells were discharged from open circuit to 0.005 V at a constant current of C/10 rate, as calculated prior from the expected theoretical capacity assuming that all tin atoms and all carbon atoms react with 4.4 and 0.5 lithium per atom, respectively. The expected theoretical capacities of Examples 2, 7, and Comparative Example A are respectively 701, 707 and 713 mAh/g. Then, the potential was increased to 2.5 V to be decreased again to 0.005 V. This was done for a total of two cycles using constant current C/10 rate. After the first two cycles, the coin cells were subsequently discharged-charged from 0.005 V to 1.2 V using a constant current C/5 rate for up to 98 cycles.

A number of embodiments of the invention have been described. Nevertheless, it will be understood that various modifications can be made without departing from the spirit and scope of the invention. Accordingly, other embodiments are within the scope of the following claims.

We claim:

1. An electrode composition comprising:
an active material comprising an alloy of tin, cobalt, and carbon,
wherein the amount of carbon is less than 9.9 weight percent (wt %) and greater than 1 wt % of the total active material.

2. The composition of claim 1, further comprising a binder comprising lithium polyacrylate.

3. The composition of claim 1, further comprising lithium.

4. The composition of claim 1, wherein the active material further comprises a material selected from indium, niobium, silicon, lead, silver, zinc, iron, germanium, titanium, molybdenum, aluminum, phosphorus, gallium, bismuth, and combinations thereof.

5. The composition of any of claim 1 wherein the active material comprises a powder.

6. The composition of claim 5 wherein the powder has a maximum crystallite dimension of less than 50 nm.

7. An electrode composition comprising:
an active material comprising an alloy of tin, cobalt, and carbon; and
a non-fluorine-containing binder or an aromatic binder or a combination thereof,
wherein the amount of active material comprises from about 10 wt % to about 30 wt % carbon and the weight ratio of cobalt to the total weight of tin and carbon is from about 0.3 to about 0.7.

8. The composition of claim 7 wherein the binder comprises lithium polyacrylate.

9. The composition of claim 8, wherein the lithium polyacrylate has a molecular weight of between 10,000 grams/mole and 3,000,000 grams/mole.

10. The composition of claim 9 wherein the lithium polyacrylate has a molecular weight of between 75,000 grams/mole and 500,000 grams/mole.

11. An electrode composition comprising:
an active material comprising an alloy of tin, cobalt, iron and carbon; wherein the amount of iron is greater than 5.9 wt % of the total amount of active material.

12. An electrode comprising:
a current collector; and
an electrode composition according to claim 1.

13. An electrode comprising:
a current collector; and
an electrode composition according to claim 7.

14. An electrode comprising:
a current collector; and
an electrode composition according to claim 11.

15. A method of making an alloy comprising:
milling together a plurality of ingredients comprising powdered carbon, powdered cobalt, and a powdered alloy that includes cobalt and tin,
wherein the powdered alloy comprises CoSn₂.

16. The method of claim 15 wherein the cobalt is provided in a molar amount that is substantially equal to the molar amount of cobalt in the alloy.

17. The method of claim 16 wherein milling comprises using an attritor mill.

18. The method of claim 15 wherein milling is performed for at least 12 hours.

19. The method of claim 18 further comprising annealing the milled alloy at a temperature of at least 500° C.
